(19) United States
(12) Patent Application Publication
(10) Pub. No.: US 2019/0329931 A1
(43) Pub. Date: Oct. 31, 2019

(54) METHOD FOR PRODUCING A CARDBOARD BOX

(71) Applicant: ESATEC - Etudes Services Automatismes Techniques, Puymoyen (FR)

(72) Inventor: Francis Laroche, Soyaux (FR)

(21) Appl. No.: 16/310,136

(22) PCT Filed: Jun. 12, 2017
(86) PCT No.: PCT/FR2017/051489

§ 371 Date: Dec. 14, 2018

(30) Foreign Application Priority Data
Jun. 16, 2016 (FR) 1655587

(51) Int. Cl. B65D 5/42; B31B 50/18; B31B 50/62; B31B 50/82; B31B 50/25

(52) U.S. Cl. CPC B65D 5/4204; B31B 50/18; B31B 2120/302; B31B 50/82; B31B 50/25; B31B 50/624

(57) ABSTRACT

A method for producing a cardboard box comprising a rigid window made of a transparent material extending over at least two adjacent faces of the box includes the following steps: supplying a continuous width of rigid transparent plastic, the width of which corresponds to the deployed width of the window; forming in the continuous width of rigid transparent plastic a succession of longitudinal cuts distributed longitudinally with a spacing corresponding to the width of the window and laterally according to the widths of the adjacent faces.

### CROSS-REFERENCE TO RELATED APPLICATIONS

This application is a national phase entry under 35 U.S.C. § 371 of International Patent Application PCT/FR2017/051489, filed Jun. 12, 2017, designating the United States of America and published as International Patent Publication WO 2017/216457 A1 on Dec. 21, 2017, which claims the benefit under Article 8 of the Patent Cooperation Treaty to French Patent Application Serial No. 1655587, filed Jun. 16, 2016.

### TECHNICAL FIELD

The present disclosure relates to a method for manufacturing packaging box window covering sheets, a machine for the automatic manufacturing of such packaging boxes, as well as the windows thus produced, and the packaging boxes provided with such windows.

### BACKGROUND

Various standard display packaging boxes with windows covered with transparent sheets are known in the state-of-the-art. Such boxes enable an effective presentation of their contents.

The general principle of the manufacture of such packaging boxes is well known in the state of the art.

The French patent FR8026305 described, for example, a display box provided with an opening overlapping at least one edge, with this opening being closed by a rigid transparent plastic sheet.

The transparent plastic window has indentations at the end of the grooves corresponding to the edges of the box, so that the edges of the sheet do not cooperate with the folding roll edge on the cardboard blank of the box.

The certificate of addition filed under FR8113025 relates to a method for manufacturing such boxes involves cutting a blank forming the box provided with an opening, and placing on this opening a sheet of transparent plastic material larger than this opening and creasing this sheet to form the incipient folding.

The boxes thus obtained have a higher rigidity than previously known boxes with a flexible plastic sheet covering the window. They are particularly noteworthy in that there is no roll edge or tearing at the connection of the sheet and the cardboard cut at the edges, due to the presence of notches extending beyond the edge of the window.

The French patent FR2496052 describes another example of the manufacture of boxes, for example, parallelepipeds, with a window overlapping at least one edge of the box. According to this known solution, the window consists of an opening in the cardboard blank closed with a rigid transparent plastic sheet. The lines of the sheet corresponding to the edges of the box are weakened and their ends are notched to prevent the sheet from overlapping the folding edges of the blank.

The French patent FR2632610 relates to a method for manufacturing window covering sheets for packaging boxes overlapping at least one edge of the box. The method involves cutting notches into a rigid transparent plastic film, gluing a flexible transparent plastic film onto the film thus prepared and cutting out covering sheets from this composite material.

The French patent FR2638393 describes the cutting of a transparent blank for the manufacture of a window packaging box, the body of which is made of cardboard.

The transparent strip flows continuously until the final cutting, after cutting the notches for folding in the corners of the cardboard.

The French patent FR2507155 describes another example of a transparent box made from a polyvinyl chloride sheath and at least one cardboard sheath provided with tabs for closing one end of the transparent tube. The assembly, by gluing the two sheaths together, makes it possible to obtain a transparent sleeve and an opaque bottom.

Patent application DE9012578 relates to a folding box with a cardboard body part being provided with a window opening with an insertion extending over at least two folding lines inside the window of a rigid transparent plastic window film, the structural strength of which is substantially equal to that of the cardboard box, and with which the window environment forms a first frame-shaped covering area, wherein the window sheet is fixedly connected to the housing, wherein the window sheet extends in the direction of the folding lines on at least one side of the window into a second overlapping area in which the window sheet has no connection with the cardboard box and is also located on either side of two folding lines, and wherein the body part within the second unbound overlapping area has a weakness line located in a housing.

The solutions of the prior art lead to the forming of a cut at the junction of the window and the cardboard, which is highly visible and unsightly. These cuts are generally triangular in shape. In addition, the position of this triangular cut results in a visible variation in the base of the cut, depending on the precision of the position of the window relative to the cardboard.

If the position of the window is not perfectly centered with respect to the opening formed in the cardboard, the difference in width of the bases of the triangular cuts on one side and the other one is clearly visible and gives a poor quality appearance.

In addition, for small boxes, triangular cuts reduce the gluing surface of the window on the cardboard.

### BRIEF SUMMARY

In order to remedy these drawbacks, the present disclosure, in its broadest sense, relates to a method for manufacturing a cardboard box having a rigid window made of a transparent material extending over at least two adjacent faces of the box, comprising the following steps:
supplying a continuous width of rigid transparent plastic, the width of which corresponds to the deployed width of the window;
forming, in the continuous width of rigid transparent plastic, a succession of longitudinal cuts having a length between 20 millimeters and 35 millimeters and a width of less than 3 millimeters, with the cuts being distributed longitudinally with a spacing corresponding to the width of the window and laterally according to the widths of the adjacent faces;
forming in the continuous width of rigid transparent plastic at least one longitudinal groove line passing through the median longitudinal axis of the longitudinal cuts;
cutting the width, to individualize the windows, according to a cross-sectional line passing through the middle of a row of longitudinal cuts;
applying one or more window piece(s) to cardboard blanks, with the adhesive on each of the one or more window piece(s) being in contact with an associated solid board, and the groove lines being aligned with one of the groove lines of the associated solid board;
The dimensions of the cuts are so selected as to reconcile the two constraints (cuts that are not very visible, but which ensure their function of allowing two materials with very different mechanical characteristics to be bent at the junction thereof); and
A succession of steps provides for the forming of the cuts and the grooving of the transparent plastic sheet before the windows are cut.

Preferably, the step of forming the cuts is carried out using an abrasive disc.

Advantageously, the cutting and/or grooving area is heated.

According to an alternative solution, dust and chips are extracted from the longitudinal cuts forming area.

The disclosure also relates to equipment for manufacturing a cardboard box having a rigid window made of a transparent material extending over at least two adjacent faces of the box comprising:
a suction belt for moving a continuous width made of rigid transparent plastic;
a station for forming, in the continuous width of rigid transparent plastic, a succession of longitudinal cuts having a length between 20 millimeters and 35 millimeters and a width of less than 15 millimeters, with the cuts being distributed longitudinally with a spacing corresponding to the width of the window and laterally according to the widths of the adjacent faces;
a station for grooving the continuous width of rigid transparent plastic;
a station for transversely cutting the continuous width of rigid transparent plastic along a transverse cutting line passing through the middle of a row of longitudinal cuts; and
a station for applying one or more window piece(s) onto cardboard blanks, with the adhesive on each of the one or more window piece(s) being in contact with an associated solid board, and with the groove lines being aligned with one of the groove lines of the associated solid board.

Preferably, the station for forming longitudinal cuts includes abrasive discs.

According to a particular embodiment, the equipment according to the disclosure includes a depth-adjustable carriage for alternately forming the longitudinal cuts and grooving the continuous width of rigid transparent plastic, with the carriage being controlled by a programmable controller for synchronization with the feed movement of the continuous width of rigid transparent plastic, depending on the length of the window.

The disclosure also relates to a cardboard box comprising a rigid window made of a transparent material extending over at least two adjacent faces of the box, with the window having at least one groove extended on either side by a cut, wherein the cuts have a length between 20 millimeters and 35 millimeters and a width of less than 3 millimeters, with the cuts being distributed longitudinally with a spacing corresponding to the width of the window and laterally according to the width of the adjacent faces.

Advantageously, the cut has two parallel edges arranged on either side of the center axis of the corresponding groove and the length L of the cut is between 1 and 1.1, 1.1 or 1 corresponding to the width of the peripheral gluing strip.

### BRIEF DESCRIPTION OF THE DRAWINGS

The method disclosed herein will be best understood when reading the following description thereof, which relates to a non-restrictive exemplary embodiment, while referring to the accompanying drawings, wherein:

FIG. 1 shows an unfolded view of a cardboard according to one embodiment of the disclosure;

FIG. 2 shows an enlarged view of area A according to one embodiment of the disclosure; and

FIG. 3 is a schematic view of a piece of equipment according to the disclosure.

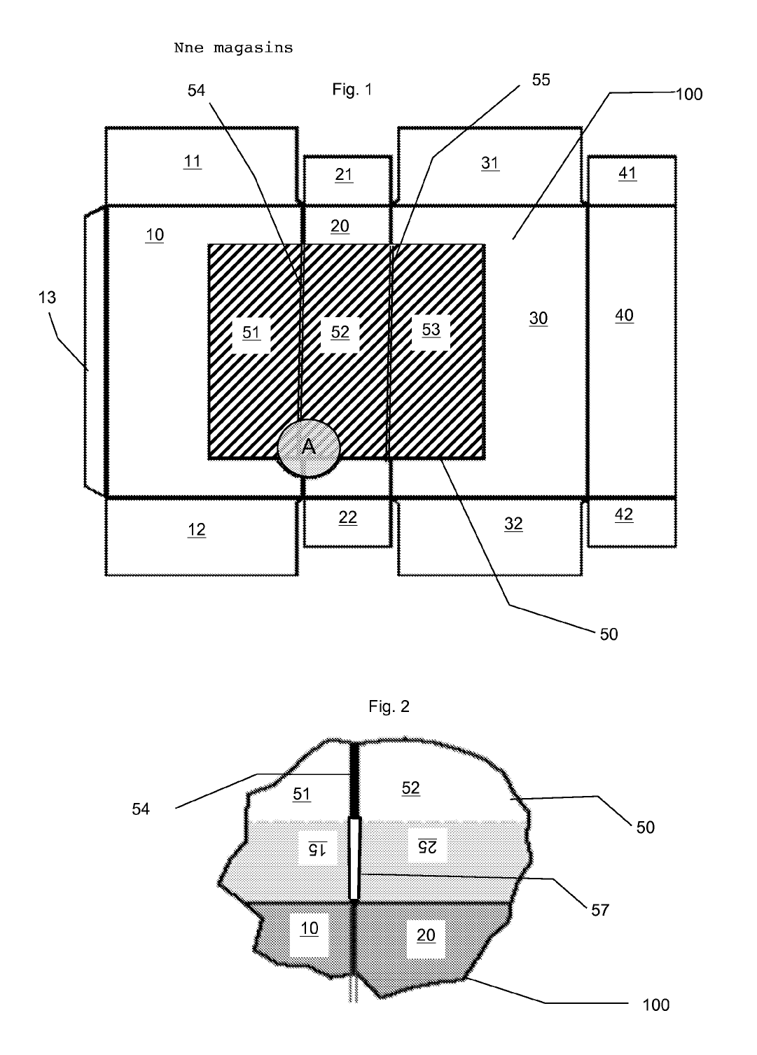

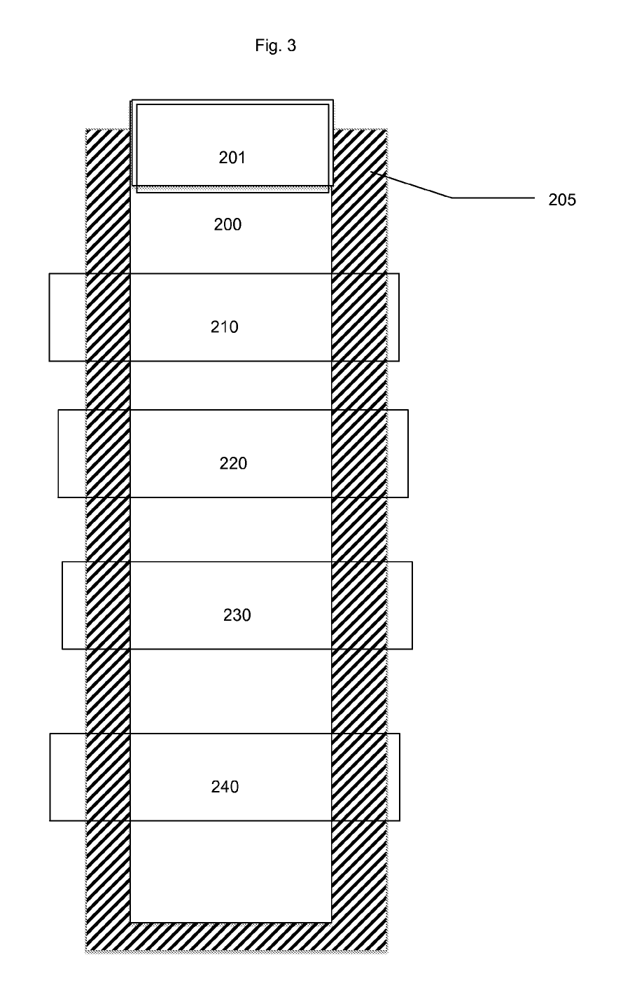

### DETAILED DESCRIPTION

The box according to this disclosure consists of a cardboard blank 100 on which a transparent plastic window 50 is glued.

The cardboard blank 100 is cut and grooved to have four lateral faces 10, 20, 30, 40 extended by upper tabs 11, 21, 31, 41 and lower tabs 12, 22, 32, 42 forming the upper and lower bottoms when the box is shaped. A side flap 13 makes it possible for the side faces to be closed by gluing.

On this cut cardboard blank 100 is glued a PVC or PET window, covering the main face 20 with a central area 52 and partially covering the lateral faces 10, 30 with lateral areas 51 and 53, respectively.

The plastic sheet window 50 is cold or hot grooved with grooves 54 and 55, facilitating the folding of the relatively rigid plastic window 50 when the assembly is shaped after gluing the plastic window 50 to the cardboard blank 100.

The window 50 has, at the ends of each groove 54, 55, a rectangular cut 57 extending from the peripheral edge of the window to the edge of the cut formed in the cardboard blank 100. The height of this cut 57 is slightly higher than the width of the gluing surfaces 15, 25 where the plastic sheet window 50 is superimposed on the cardboard blank 100. Typically, the height of the cut 57 is between 1 and 1.1 times the width of this overlapping area 15, 25, the width of which is typically about 12 millimeters. The width of the cut 57 is about 1.5 millimeters for a thin window, typically 3 millimeters.

The equipment for manufacturing such boxes includes a vacuum conveyor belt 205 driving the continuous width of transparent plastic 200 from an unwinder 201. The width of the continuous width of transparent plastic 200 corresponds to the width of the window 50.

A first station, cutting station 210, includes means for forming the cut alignments, by consecutive transverse series. These cuts have a height twice that of the final cut of a window 50, e.g., from 20 mm to 40 mm.

These cuts can be formed by abrasive discs rotating at high speed, such as above 50,000 rpm. They can also be formed by water jet cutting, laser cutting or use any other means.

This workstation operates synchronously with the scrolling of the width of transparent plastic 200 to produce a line of cuts 57 at regular intervals corresponding to the width of the window 50.

The abrasive disc is mounted on a depth-adjustable carriage to successively cut and groove the PVC window, and is synchronized with the feed movement of the coil, depending on the length of the window.

The feed rate of the width is controlled by a servomotor controlled by a programmable logic controller (PLC) to determine the spacing between each one.

The next station, grooving station 220, performs hot or cold grooving to continuously form the grooves 54, 55 on the continuous width of transparent plastic 200. These lines pass through the longitudinal cuts made at cutting station 210.

The cutting and grooving may be carried out in one and the same station.

The so cut and grooved width of transparent plastic 200 then passes through a station 230 making a transverse cut to individualize the windows. These cuts pass through the middle of the longitudinal cut alignments.

It should be noted that the grooving station 220 can be located upstream or downstream of the cutting station 210.

Next, a receiver station 240 stacks the prepared windows and a destacker picks them up one by one to move them onto a cardboard blank to perform the gluing.

The features of the various embodiments described herein are not mutually exclusive and can exist in various combinations and permutations, even if such combinations or permutations are not expressly described herein, without departing from the scope of the disclosure. In fact, variations, modifications, and other implementations of what is described herein will occur to one of ordinary skill in the art without departing from the scope of the disclosure. As such, the invention is not to be defined only by the preceding illustrative description, but only by the claims which follow, and legal equivalents thereof.

1.-12. (canceled)

13. A method for producing a cardboard box comprising a rigid window made of a transparent material extending over at least two adjacent faces of the box, the method comprising:
supplying a continuous width of rigid transparent plastic, a width of the rigid transparent plastic corresponding to a width of the window;
forming a succession of longitudinal cuts in the continuous width of rigid transparent plastic, the succession of longitudinal cuts distributed longitudinally with a spacing corresponding to the width of the window and laterally according to widths of the at least two adjacent faces;
forming at least one longitudinal groove line on the continuous width of rigid transparent plastic, the at least one longitudinal groove line passing through a median longitudinal axis of the longitudinal cuts;
cutting the width of rigid transparent plastic to individualize windows according to a cross-sectional line passing through a middle of a row of longitudinal cuts; and
applying one or more of the individualized windows onto cardboard blanks comprising at least two faces with a groove line therebetween, with adhesive on each of the one or more individualized windows being in contact with an associated cardboard blank, the at least one longitudinal groove line on the continuous width of rigid transparent plastic being aligned with the groove line between the at least two faces of the associated cardboard blank.

14. The method of claim 13, wherein forming the longitudinal cuts is carried out using an abrasive disc.

15. The method of claim 14, further comprising heating areas of the continuous width of rigid transparent plastic.

16. The method of claim 15, further comprising forming the cuts of the succession of longitudinal cuts in the heated areas.

17. The method of claim 15, further comprising forming the at least one longitudinal groove line in a heated area of the heated areas.

18. The method of claim 13, further comprising extracting dust and chips from the areas of the cuts of the succession of longitudinal cuts.

19. The method of claim 13, wherein the cuts of the succession of longitudinal cuts have a length between 20 millimeters and 35 millimeters and a width of less than 3 millimeters.

20. A system for manufacturing a cardboard box having a rigid window made of a transparent material extending over at least two adjacent faces of the box, the system comprising:
a suction belt for moving a continuous width of rigid transparent plastic;
a station for forming, in the continuous width of rigid transparent plastic, a succession of longitudinal cuts distributed longitudinally with a spacing corresponding to a width of the window and laterally according to widths of the adjacent faces;
a station for forming grooves on the continuous width of rigid transparent plastic;
a station for transversely cutting the continuous width of rigid transparent plastic along a transverse cutting line passing through the middle of a row of longitudinal cuts; and
a station for applying one or more windows onto cardboard blanks comprising at least two faces with a groove line therebetween, with adhesive on the windows being in contact with an associated cardboard blank, a groove on the continuous width of rigid transparent plastic being aligned with the groove line between the at least two faces of the associated cardboard blank.

21. The system of 20, wherein the station for forming longitudinal cuts comprises abrasive discs.

22. The system of claim 20, further comprising a depth-adjustable carriage for alternately forming the longitudinal cuts and the grooves on the continuous width of rigid transparent plastic, the carriage being controlled by a programmable controller for synchronization with movement of the continuous width of rigid transparent plastic, as a function of a length of the windows.

23. The system of claim 20, wherein the station for forming the succession of longitudinal cuts in the width of rigid transparent plastic is configured to form the longitudinal cuts to have a length between 20 millimeters and 35 millimeters, with the cuts being distributed longitudinally with a spacing corresponding to the width of the window and laterally according to the widths of the adjacent faces.

24. A cardboard box comprising a rigid window made of a transparent material extending over at least two adjacent faces of the box, the window having at least one groove extended on each opposing side by a cut, wherein the cuts are distributed longitudinally with a spacing corresponding to a width of the window and laterally according to widths of the adjacent faces.

25. The cardboard box of claim 24, wherein the cut has two parallel edges arranged on either side of the center axis of the corresponding groove and, wherein a length of each cut is between 1 and 1.1 times a width of a peripheral gluing strip.

26. The cardboard box of claim 24, wherein each cut has a length between 20 millimeters and 35 millimeters and a width of less than 3 millimeters.
